(19) United States
(12) Patent Application Publication
(10) Pub. No.: US 2021/0252581 A1
(43) Pub. Date: Aug. 19, 2021

(54) 3D Printed Tools And Associated Methods

(71) Applicant: Cincinnati Incorporated, Harrison, OH (US)

(72) Inventors: Gary Todd, Union, KY (US); Mark Watson, Elmhurst, IL (US)

(21) Appl. No.: 17/308,666

(22) Filed: May 5, 2021

Related U.S. Application Data
(63) Continuation-in-part of application No. PCT/US2019/056506, filed on Oct. 16, 2019.
(60) Provisional application No. 62/755,743, filed on Nov. 5, 2018.

(51) Int. Cl. B21D 37/10; B33Y 80/00

(52) U.S. Cl. CPC B21D 37/10; B33Y 80/00

(57) ABSTRACT

A 3D printed tool includes a tool body extending between first and second ends and including at least one loading surface defining an axis, at least one support surface configured to receive a clamp, and a structural weakness portion positioned along the axis between the at least one loading surface and the at least one support surface. The structural weakness portion is configured to cause the at least one tool body to fail along a predetermined fault line such that the at least one tool body splits substantially down a middle of the at least one tool body when overloaded.

### CROSS-REFERENCE TO RELATED APPLICATIONS

This application is a Continuation-In-Part of International Patent Application No. PCT/US2019/056506 filed Oct. 16, 2019 (pending), which claims priority to U.S. Provisional Application Ser. No. 62/755,743 filed on Nov. 5, 2018 (expired), the disclosures of which are hereby incorporated by reference in their entirety.

### FIELD OF THE INVENTION

The present invention relates generally to 3D printed tools and, more particularly, to 3D printed tools having an intended strategic weakness for providing controlled failure of the tools when overloaded.

### BACKGROUND OF THE INVENTION

3D printed tools or tools made by additive manufacturing techniques can be used in place of tools manufactured via more traditional techniques in various material fabrication applications. For example, 3D printed tools may be used as punches or dies in machines such as press brakes. Press brakes are used for bending sheet and plate material, such as sheet metal. Such 3D tools might also be used, or as components of any other fabrication application or process that bends, stamps, punches, forms, or otherwise applies a force manually or automatically to a workpiece. 3D printed tools can allow for rapid experimentation while minimizing custom tooling cost. Thus, 3D printed tools are particularly attractive in rapid design, prototyping, and production applications that can benefit from expendable tooling.

While 3D printed tools have successfully formed parts in a variety of metals without failure, continuing to increase the applied force beyond the useful load requirement of a 3D printed tool can yield an unpredictable tool failure. As such 3D printed tools may be printed as solid or near solid parts using plastics, plastic composites, polymers, and/or metallic materials. As a result, 3D printed tools tend to be brittle and may fail under a threshold applied force. While unlikely, printing errors can also contribute to failure of 3D printed tools. When failing, a 3D printed tool can catastrophically explode or shatter into numerous pieces which may propel away from the press brake or other machine, thereby causing a hazardous condition for the operator of the press brake/machine.

Current tool safety measures are based on factors of safety, or multiples of strength beyond the proposed useful loading of the tool. Nevertheless, 3D printed tools are still subject to being overloaded and broken, whether intentionally or unintentionally. There is always the ability to overload a tool, even with an extreme factor of safety. Indeed, a 3D printed tool having a greater factor of safety may experience a catastrophic failure of a greater energy relative to that of a tool having a lesser factor of safety when failure eventually occurs.

Thus, it would be desirable to provide an improved 3D printed tool that overcomes these and other deficiencies in the prior art.

### SUMMARY OF THE INVENTION

In one embodiment, a 3D printed tool includes a tool body extending between first and second ends and including at least one loading surface defining an axis, at least one support surface configured to receive a clamp, and at least one structural weakness portion positioned along the axis between the at least one loading surface and the at least one support surface. The structural weakness portion is configured to cause the at least one tool body to fail along a predetermined fault line such that the at least one tool body splits substantially down a middle of the at least one tool body when overloaded. In one embodiment, the at least one loading surface includes first and second angled loading surfaces defining a V-notch. The at least one predetermined structural weakness may include at least one depression positioned along the axis and opening to the at least one loading surface.

In one embodiment, the at least one predetermined structural weakness portion may include at least one slot. In this regard, the at least one slot may be positioned along the axis and closed off from the at least one loading surface. The at least one slot may be generally teardrop-shaped or generally W-shaped. In one embodiment, the at least one slot extends between the first and second ends of the at least one tool body. In addition or alternatively, the at least one slot may include first and second notches provided along first and second surfaces of the slot, respectively. The tool body may include first and second tool body portions, and the at least one slot may be at least partially defined between the first and second tool bodies.

In another embodiment, a method of using a 3D printed tool includes overloading the 3D printed tool such that the 3D printed tool fails along a predetermined fault line and splits substantially down a middle of the 3D printed tool. Overloading the 3D printed tool may be performed while engaging the 3D printed tool with a workpiece. In one embodiment, the 3D printed tool includes at least one of a punch or a die, and engaging the 3D printed tool with the workpiece bends the workpiece. In addition or alternatively, overloading the 3D printed tool may cause a crack to form between a V-notch of the 3D printed tool and a slot of the 3D printed tool. In this regard, after failure of the 3D printed tool, portions of the 3D printed tool on either side of the may crack flex away from each other.

In yet another embodiment, a punch for a press brake includes a first tool body portion including at least one support surface configured to receive a clamp, and a second tool body portion including a V-shaped tip portion defined by first and second angled loading surfaces configured to shape a workpiece. The second tool body is removably coupled to the first tool body. The punch may further include first and second flexible tabs integrally formed together with the tool body portion as a unitary piece or formed with one of the tool body portions. In addition or alternatively, the first tool body may include a V-notch and the second tool body may include a V-shaped wedge portion received by the V-notch. The first tool body may include at least one structural weakness portion positioned between the at least one loading surface and the second tool body. In one embodiment, the first tool body includes a die.

### BRIEF DESCRIPTION OF THE DRAWINGS

Various additional features and advantages of the invention will become more apparent to those of ordinary skill in the art upon review of the following detailed description of one or more illustrative embodiments taken in conjunction with the accompanying drawings. The accompanying drawings, which are incorporated in and constitute a part of this specification, illustrate one or more embodiments of the invention and, together with the general description given above and the detailed description given below, serve to explain the one or more embodiments of the invention.

FIG. 1 is a perspective view of a press brake including exemplary 3D printed tools in the forms of a die and a punch, in accordance with an aspect of the invention.

FIG. 2 is a perspective view of the die of FIG. 1.

FIG. 3 is a cross sectional view of the die, taken along section line 3-3 in FIG. 2.

FIG. 4 is a magnified view of area 4 in FIG. 3, showing an intentionally weakened portion of the die.

FIGS. 5A-5E are cross sectional views similar to FIG. 3, showing a guided failure of the die when overloaded by the punch.

FIG. 6 is a cross sectional view of an exemplary 3D printed tool in the form of an alternative die.

FIGS. 7A-7E are cross sectional views similar to FIG. 6, showing a guided failure of the die when overloaded by the punch.

FIG. 8 is a cross sectional view of an exemplary 3D printed tool in the form of an alternative die.

FIG. 9 is a perspective view of the punch of FIG. 1.

FIG. 10 is a cross sectional view of the punch, taken along section line 10-10 in FIG. 9.

FIGS. 11A-11E are cross sectional views similar to FIG. 10, showing a guided failure of the punch when overloaded by the die.

FIG. 12 is a cross sectional view of an exemplary 3D printed tool in the form of an alternative punch.

FIGS. 13A-13F are diagrams of various exemplary 3D printed tools labeled with certain variable dimensions.

FIGS. 14A-14D are tables of exemplary dimensional relationships associated with the various 3D printed tools shown in FIG. 13.

### DETAILED DESCRIPTION OF THE INVENTION

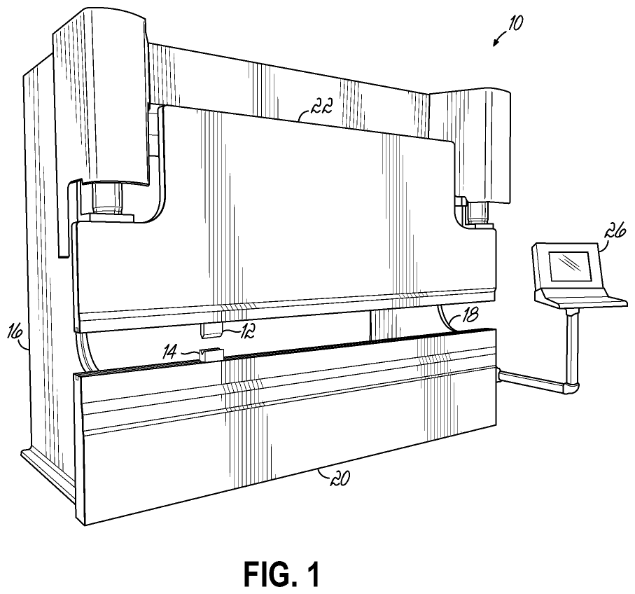

With reference to FIG. 1, a machine, for example, press brake 10 is shown. The press brake includes a punch 12 and a die 14 that works in conjunction with the punch. As described below, in accordance with the invention, one or both of the punch 12 and the die 14 may be a 3D printed tool. In this regard, the punch 12 and/or die 14 may be 3D printed using plastics, plastic composites, polymers, and/or metallic materials, for example, such as PLA (Polylactic Acid), Carbon Fiber Nylon, and Ultem® 9085.

The properties of the 3D printed punch 12 and/or die 14 made from plastics, plastic composites, polymers, and/or metallic materials are defined at least in part by the specific composition of the material or materials used to make the punch 12 and/or die 14, as well as the molecular weight of the material, particularly when using plastics, plastic composites, or polymers. PLA includes several types—racemic Poly-L-lactic Acid; regular Poly-L-lactic Acid; Poly-D-lactic Acid; and Poly-DL-lactic Acid. The PLA melt temperature falls in the typical range of about 155-175° C., with a flexural strength in the typical range of about 45-115 MPa. Representative PLA for use in preparing a punch 12 and/or die 14 can be obtained from Makeshaper, Keene Village Plastics, Barberton, Ohio; and from Toner Plastics, East Longmeadow, Mass. Carbon Fiber Nylon (chopped carbon fiber reinforced nylon under the CarbonX brand) for 3D printing applications typically uses Nylon 6 or 12 in the preparation of the composite material. Representative Carbon Fiber Nylon can be obtained from 3DX Tech, Grand Rapids, Mich. Ultem® 9085 is a polyetherimide thermoplastic material from SABIC Innovative Plastics, Selkirk, N.Y. It features a high strength-to-weight ratio and higher ultimate tensile strength when compared to Nylon 12.

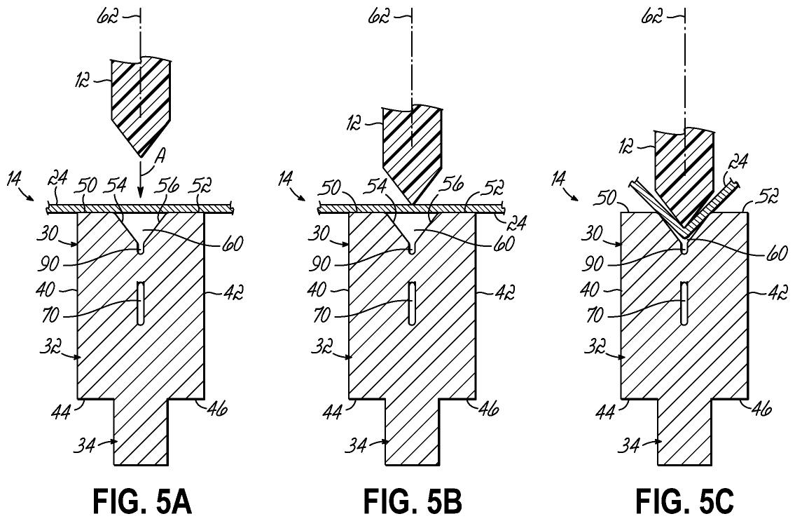

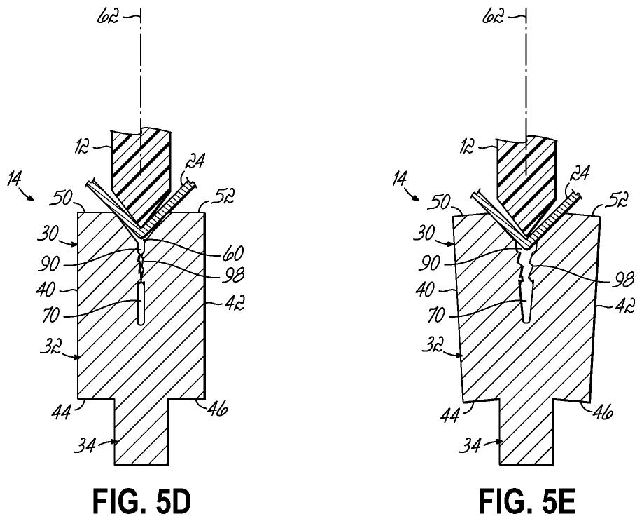

The illustrated press brake 10 also includes first and second C-frames 16, 18 forming the sides of the press brake 10 and each connected to a stationary bed 20 at or near the bottoms thereof. The C-frames carry a movable ram 22 at or near the tops thereof and above the bed 20. The die 14 is mounted on the bed 20 and the punch 12 is mounted on the ram 22 opposite the die 14. The press brake 10 may be used to form predetermined bends in a workpiece 24 (see, for example, FIGS. 5A-5C) such as sheet metal, by pressing the workpiece 24 between the punch 12 and the die 14. In one embodiment, the press brake 10 may be configured to apply a pressing or bending force of between approximately % ton per foot and approximately 25 tons per foot. In another embodiment, the press brake 10 may be configured to apply a pressing or bending force of less than approximately 10 tons per foot. For example, 16 ga Mild Steel may require 2.5-3.5 tons per foot of pressing or bending force when using a 0.500 inch vee die. Operation of the press brake 10 may be conducted via a controller 26, for example. While the punch 12 and the die 14 are shown extending along only a relatively short portion of the length of the ram 22 and bed 20, respectively, it will be appreciated that the punch 12 and the die 14 may be of any suitable length(s) as appropriate for their purposes.

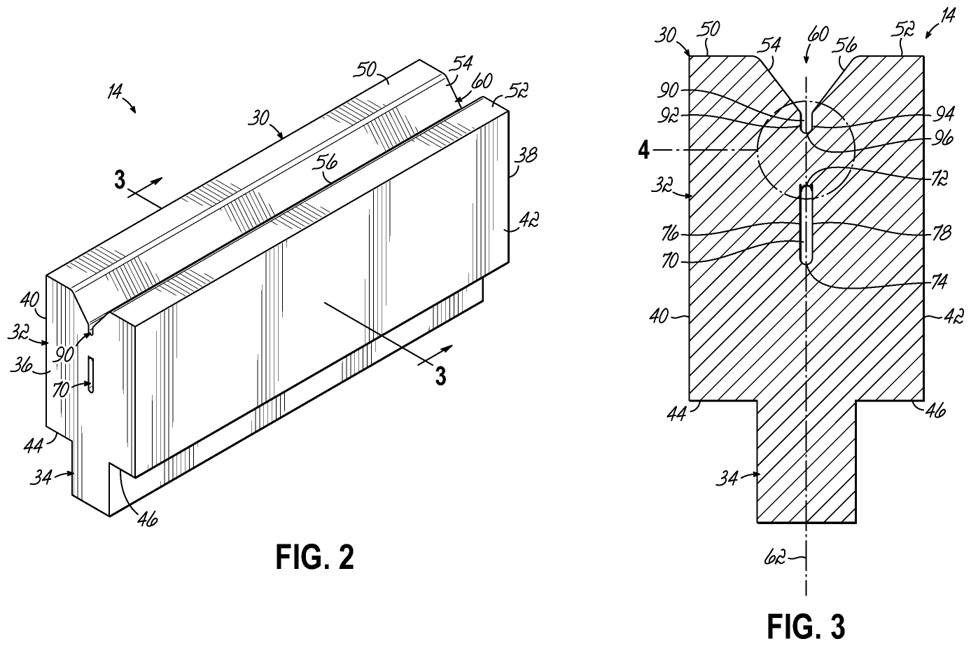

Referring now to FIGS. 2-4, the illustrated die 14 includes a tool body 30 having a main portion 32 and a stem portion or “tongue” 34 that extends between first and second ends 36, 38. The main portion 32 defines first and second sides 40, 42 of the die 14, and includes first and second lower support surfaces 44, 46 proximate tongue 34, and first and second upper loading surfaces 50, 52 generally parallel to the first and second lower support surfaces 44, 46. The main portion 32 also includes first and second angled loading surfaces 54, 56 configured to assist in shaping the workpiece 24 when the workpiece 24 is pressed between the punch 12 and the die 14. In this regard, the angled loading surfaces 54, 56 together define a V-shaped die opening or V-notch 60 and further define a loading axis or plane 62 provided at or near an apex of the V-notch 60. The axis reference 62 extending from end to end in body 30 forms a plane, but the term axis will be used herein to note that spatial reference. The axis is an axis extending from top to bottom in the body or from loading surfaces 50, 52, 54, 56 to the support surfaces 44, 46 and stem portion as shown in FIG. 3. The illustrated loading axis 62 is generally centered between the first and second sides 40, 42. The V-notch may have any desired die angle depending on the desired bend. In one embodiment, the V-notch 60 may be defined by a die angle of about 75°, for example.

As shown, the stem portion 34 is positioned along the loading axis 62 and is configured to be received by a clamp of the press brake, for example, in order to secure the die 14 to the bed 20 of the press brake 10. The first and second support surfaces 44, 46 are positioned on the main portion 32 proximate the stem portion 34 and may be configured to rest upon or otherwise receive such a clamp, for example, in order to assist in stabilizing the die 14 on the bed 20 of the press brake 10 in alignment with the punch 12.

The illustrated die 14 further includes a first intended structural weakness portion or area or structural fuse in the body. In the embodiment of FIGS. 2 and 3, the intended structural weakness portion is in the form of a slot 70 extending between the first and second ends 36, 38 of the tool body 30. The slot is generally positioned along the axis 62 in the main portion 32 between the loading surfaces 50, 52, 54, 56 and the support surfaces 44, 46. The slot 70 is a calibrated weak spot or structural weakness portion in the tool body 30 which provides for a predetermined, guided failure of the die 14 when the die is overloaded. The slot 70 may be configured to direct and control an ultimate failure of the die 14, to reduce applied forces after failure occurs, and/or to allow the die 14 to flex after failure rather than explode or shatter.

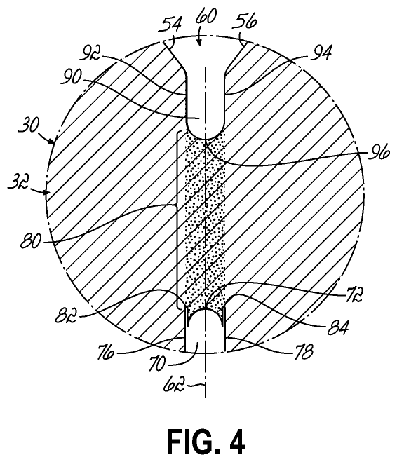

In this regard, the slot 70 extends along the loading axis 62 between an upper end 72 and a lower end 74 of the slot and is closed off from the loading surfaces 50, 52, 54, 56 by a portion of the body as seen in FIG. 3. In the embodiment shown, the slot 70 includes first and second slot surfaces 76, 78 parallel to each other and the upper and lower ends 72, 74 are each partially defined by a radius such that the slot 70 may have a generally rounded rectangular shape in an exemplary embodiment as illustrated. As a result, and as best shown in FIG. 4, the portion 80 of the body 30 extending between the upper end 72 of the slot 70 and the V-notch 60 has a reduced material thickness and is intentionally structurally weak relative to the remaining portions of the body 30. Thus, the die 14 may be prone to fracture along the structural weakness portion 80 of the body 30 when overloaded, as described below. Although variable with different materials and printing methods, this fracture may generally occur at a load approximately 50% greater than the loading necessary for the bending function of the tool.

The illustrated structural weakness portion, in the form of slot 70, includes first and second upwardly-extending notches 82, 84 provided along the first and second slot surfaces 76, 78 at or near the upper end 72 of the slot 70. The first and second notches 82, 84 may serve as an additional guide for controlling the direction of the propagating fracture toward the slot 70 when the die 14 is overloaded. The first and second notches 82, 84 may be present in embodiments where the slot 70 is relatively narrow in width, such as about 0.124 inch, and/or in embodiments where the slot 70 is substantially spaced apart from the expected origin of the fracture, such as about 0.25 inch (e.g., from the V-notch 60 and/or depression 90 described below). In other embodiments, the first and second notches 82, 84 may be eliminated, such as in embodiments where the slot 70 or other intended structural weakness is relatively larger in width and/or closer to the expected origin of the fracture. In such cases, the propagating fracture may find its own way to the slot 70 or other intended structural weakness portion without additional guidance.

In the embodiment shown, the die 14 includes a second intended structural weakness portion in the form of a depression 90 extending between the first and second ends 36, 38 of the tool body 30. The structural weakness portion 90 is positioned along the axis 62 and opens to the first and second angled loading surfaces 54, 56 as shown in FIG. 4. In this regard, the depression 90 is provided at or near the apex of the V-notch 60. In the embodiment shown, the depression 90 includes first and second depression surfaces 92, 94 parallel to each other and an end 96 partially defined by a radius such that the depression 90 may be generally U-shaped. The depression 90 may further weaken the weakened portion 80 of the body 30 extending between the upper end 72 of the slot 70 and the V-notch 60 by further reducing the material thickness of the weakened portion 80. Thus, the depression 90 may contribute to the tendency of the die 14 to fracture along the weakened portion 80 of the body 30 and into the slot 70 when overloaded.

In one embodiment, the height of the main portion 32 of the body may be approximately 1.75 inch, the width of the main portion 32 may be approximately 1.19 inch, the height of the stem portion of the body 34 may be approximately 0.62 inch, and the width of the stem portion 34 may be approximately 0.5 inch. The distance between the upper end 72 of the slot 70 and the end 96 of the depression 90 (e.g., the height of the weakened portion 80) may be approximately 0.25 inch. For example, the upper end 72 of the slot 70 and the end 96 of the depression 90 may each be partially defined by a radius of approximately 0.063 inch, and the center points of the radii of the upper end 72 of the slot 70 and the end 96 of the depression 90 may be spaced apart from each other by approximately 0.375 inch.

In addition or alternatively, the center points of the radii of the upper and lower ends 72, 74 of the slot 70 may be spaced apart from each other by approximately 0.375 inch such that the slot 70 may have a total height of approximately 0.5 inch. In another embodiment, the center points of the radii of the upper and lower ends 72, 74 may be spaced apart from each other by approximately 0.5 inch, such that the slot 70 may have a total height of approximately 0.625 inch. In another embodiment, the center points of the radii of the upper and lower ends 72, 74 may be spaced apart from each other by approximately 0.625 inch, such that the slot 70 may have a total height of approximately 0.75 inch. The illustrative dimensions provided herein are exemplary and are not intended to be limiting.

Referring now to FIGS. 5A-5E, a guided failure of the tool in the form of die 14 when overloaded by the punch 12 is illustrated. Initially, a flat workpiece 24 is positioned between the punch 12 and the loading surfaces 50, 52, 54, 56 of the die 14, such as the upper loading surfaces 50, 52. Another tool, such as punch 12 is advanced toward the workpiece 24, and thus the die 14, along the loading axis 62 as indicated by the arrow A (FIG. 5A). When the punch 12 begins to engage the workpiece 24, the load on the die 14 may be substantially vertical (e.g., parallel to the loading axis 62) as the force is applied to the upper loading surfaces 50, 52 of the die 14 via the workpiece 24 (FIG. 5B). The load on the die 14 rotates away from vertical as the workpiece 24 is bent deeper into the V-notch 60, and the final load on the die 14 may be angled relative to vertical (e.g., relative to the loading axis 62) as the force is applied to the angled loading surfaces 54, 56 via the bent workpiece 24 (FIG. 5C). The weakened portion 80 may fail in tension when the die 14 is overloaded by the force applied by the punch 12 to the angled loading surfaces 54, 56, resulting in a fracture or crack 98 along the loading axis 62 between the V-notch 60 (and/or depression 90) and the upper end 72 of the slot 70 (FIG. 5D) before any explosive or catastrophic breakage can occur and thus prevent the portions of the tool body 30 on either side of the crack 98, slot 70, and/or axis 62 from being propelled. After the weakened portion 80 fails in this manner, thereby causing a significant reduction in the load applied to the die 14, the portions of the tool body 30 on either side of the crack 98, slot 70, and/or axis 62 can flex away from each other without explosive or catastrophic breakage (FIG. 5E).

Thus, the intended weakness from the structural weakness portion is capable of controlling the force profile applied to the die 14 by the punch 12 so as to control the failure of the die 14 along an intended and predetermined fault line that allows the die 14 to split substantially down the middle of the die 14. In one embodiment, the force resistance or stiffness of the die 14 at or near the angled loading surfaces 54, 56 may be significantly reduced when the splitting failure (e.g., propagation of the crack 98) occurs. This may effectively reduce the spring constant of the portions of the tool body 30 on either side of the crack 98, slot 70, and/or axis 62, thereby allowing them to readily flex away from each other rather than catastrophically explode. In one embodiment, the printing direction used during manufacture of the die 14 may contribute to the flexibility of the die 14 in accomplishing this action. In addition or alternatively, the load applied to the die 14 may reduce immediately to a small percentage of the original load once the splitting failure occurs. For example, the load applied to the die 14 immediately after the splitting failure may reduce to less than 10% of the original load applied to the die 14 by the punch 12. Thus, the stresses in the die 14 may nearly dissipate immediately.

In this manner, the die 14 may be constructed of a relatively weak, printed material that may be susceptible to failure when overloaded. However, such failure is guided in a safe manner. In particular, the intended strategic weaknesses provided in the die 14 determine in advance the direction of the failure and reduce the total energy of the failure relative to that of higher strength and/or higher factor of safety designs. Thus, the 3D printed die 14 may be safe for normal operation of the press brake 10, even if rated at a relatively low factor of safety compared to tools manufactured via more traditional techniques.

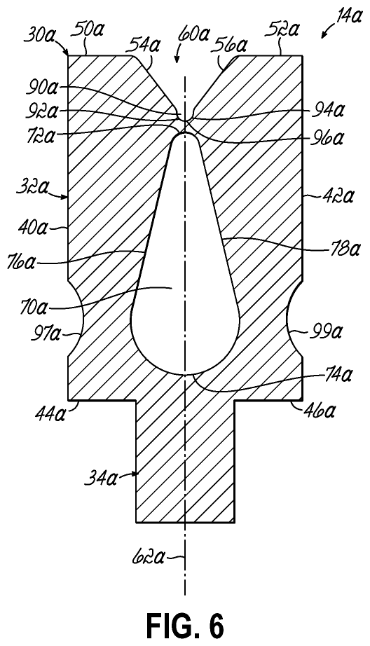

Referring now to FIG. 6, an alternative die 14a includes a tool body 30a having a main body portion 32a and a stem portion 34a extending between first and second ends (not shown). The main portion 32a includes first and second sides 40a, 42a, first and second lower support surfaces 44a, 46a, and first and second upper loading surfaces 50a, 52a generally parallel to the first and second lower support surfaces 44a, 46a. The main portion 32a also includes first and second angled loading surfaces 54a, 56a configured to assist in shaping the workpiece 24 when the workpiece 24 is pressed between the punch 12 and the die 14a. In this regard, the angled loading surfaces 54a, 56a together define a V-shaped die opening or V-notch 60a and further define a loading axis 62a provided at or near an apex of the V-notch 60a. The illustrated loading axis 62a is generally centered between the first and second sides 40a, 42a. In one embodiment, the V-notch 60a may be defined by a die angle of about 75°, for example.

As shown, the stem portion 34a is positioned along the loading axis 62a and is configured to be received by a clamp, for example, in order to secure the die 14a to the bed 20 of the press brake 10. The first and second support surfaces 44a, 46a are positioned on the main portion 32a proximate the stem portion 34a and may be configured to rest upon or otherwise receive such a clamp, for example, in order to assist in stabilizing the die 14a on the bed 20 of the press brake 10.

The illustrated die 14a further includes a first intended structural weakness portion or structural fuse in the form of a slot 70a extending between the first and second ends of the tool body 30a and positioned along the axis 62a in the main portion 32a between the loading surfaces 50a, 52a, 54a, 56a and the support surfaces 44a, 46a. The slot 70a is a calibrated weak spot in the tool body 30a which provides for a predetermined, guided failure of the die 14a when overloaded. The slot 70a may be configured to direct and control an ultimate failure of the die 14a, to reduce applied forces after failure occurs, and/or to allow the die 14a to flex after failure rather than explode or shatter as described herein.

In this regard, the slot 70a extends along the loading axis 62a between an upper end 72a of the slot and a lower end 74a and is closed off from the loading surfaces 50a, 52a, 54a, 56a. In the embodiment shown, the slot 70a includes first and second slot surfaces 76a, 78a angled relative to each other, the upper end 72a is partially defined by a first radius, and the lower end 74a is partially defined by a second radius greater than the first radius. With surfaces 76a, 78a extending between the different radii, the slot 70a is generally teardrop-shaped. As a result, the portion of the body 30a extending between the upper end 72a of the slot 70a and the V-notch 60a has a reduced material thickness and is structurally weak relative to the remaining portions of the body 30a. Thus, the die 14a may be prone to fracture along the weakened portion of the body 30a when overloaded, in a manner similar to that described above with respect to the die 14.

In the embodiment shown in FIG. 6, the die 14a includes a second intended structural weakness portion in the form of a depression 90a extending between the first and second ends of the tool body 30a and positioned along the axis 62a and opening to the first and second angled loading surfaces 54a, 56a. In this regard, the depression 90a is provided at or near the apex of the V-notch 60a. In the embodiment shown, the depression 90a includes first and second depression surfaces 92a, 94a parallel to each other and an end 96a partially defined by a radius such that the depression 90a may be generally U-shaped. The depression 90a may further weaken the weakened portion of the body 30a extending between the upper end 72a of the slot 70a and the V-notch 60a by further reducing the material thickness of the weakened portion. Thus, the depression 90a may contribute to the tendency of the die 14a to fracture along the weakened portion of the body 30a when overloaded.

The illustrated die 14a also includes a third intended structural weakness portion in the form of first and second grooves 97a, 99a extending along the first and second sides 40a, 42a of the main portion 32a of the tool body 30a. The grooves 97a, 99a may provide an increased load carrying capacity of the die 14a during the bending process while adding flexibility to improve energy dissipation after the weakened portion of the body 30a has fractured. The first and second grooves 97a, 99a may be included in embodiments where the die 14a is constructed of relatively brittle materials, for example.

In one embodiment, the height of the main portion 32a may be approximately 1.75 inch, the width of the main portion 32a may be approximately 1.19 inch, the height of the stem portion 34a may be approximately 0.62 inch, and the width of the stem portion 34a may be approximately 0.5 inch. As described above, the V-notch 60a may be defined by an angle included between the first and second angled loading surfaces 54a, 56a, which may be approximately 75°. Moreover, the standard tooling radius at the apex of the V-notch 60a and/or at the intersection of the first and second angled loading surfaces 54a, 56a may be approximately 0.03 inch. In the embodiment shown, the lengths of the first and second depression surfaces 92a, 94a are close to or equal to 0 inches. The radius of the end 96a of the depression 90a may be concentric to the tooling radius at the apex of the V-notch 60a and may be approximately equal to 0.045 inch. Blending radii on either side of the radius of the end 96a tangent to surface of the radius of the end 96a and the first and second angled loading surfaces 54a, 56a may be approximately 0.045 inches, for example.

The distance between the upper end 72a of the slot 70a and the end 96a of the depression 90a (e.g., the height of the weakened portion) may be approximately 0.25 inch. For example, the upper end 72a of the slot 70a and the end 96a of the depression 90a may each be partially defined by a first radius of approximately 0.063 inch, and the center points of the radii of the upper end 72a of the slot 70a and the end 96a of the depression 90a may be spaced apart from each other by approximately 0.375 inch. In another embodiment, the distance between the upper end 72a of the slot 70a and the end 96a of the depression 90a may be approximately 0.028 inch. In another embodiment, the distance between the upper end 72a of the slot 70a and the end 96a of the depression 90a may be approximately 0.268 inch. In another embodiment, the distance between the upper end 72a of the slot 70a and the end 96a of the depression 90a may be approximately 0.088 inch. In another embodiment, the distance between the upper end 72a of the slot 70a and the end 96a of the depression 90a may be approximately 0.117 inch. In another embodiment, the distance between the upper end 72a of the slot 70a and the end 96a of the depression 90a may be approximately 0.147 inch. In another embodiment, the distance between the upper end 72a of the slot 70a and the end 96a of the depression 90a may be approximately 0.056 inch. In another embodiment, the distance between the upper end 72a of the slot 70a and the end 96a of the depression 90a may be approximately 0.173 inch. In another embodiment, the distance between the upper end 72a of the slot 70a and the end 96a of the depression 90a may be approximately 0.208 inch. In another embodiment, the distance between the upper end 72a of the slot 70a and the end 96a of the depression 90a may be approximately 0.237 inch.

In addition or alternatively, the end 96a of the depression 90a may be partially defined by a second radius of approximately 0.125 inch, and the center points of the radii of the upper and lower ends 72a, 74a of the slot 70a may be spaced apart from each other by approximately 0.375 inch such that the slot 70a may have a total height of approximately 0.56 inch. In another embodiment, the center points of the radii of the upper and lower ends 72a, 74a may be spaced apart from each other by approximately 0.5 inch, such that the slot 70a may have a total height of approximately 0.69 inch. In another embodiment, the center points of the radii of the upper and lower ends 72a, 74a may be spaced apart from each other by approximately 0.625 inch, such that the slot 70a may have a total height of approximately 0.81 inch. The illustrative dimensions provided herein are exemplary and are not intended to be limiting.

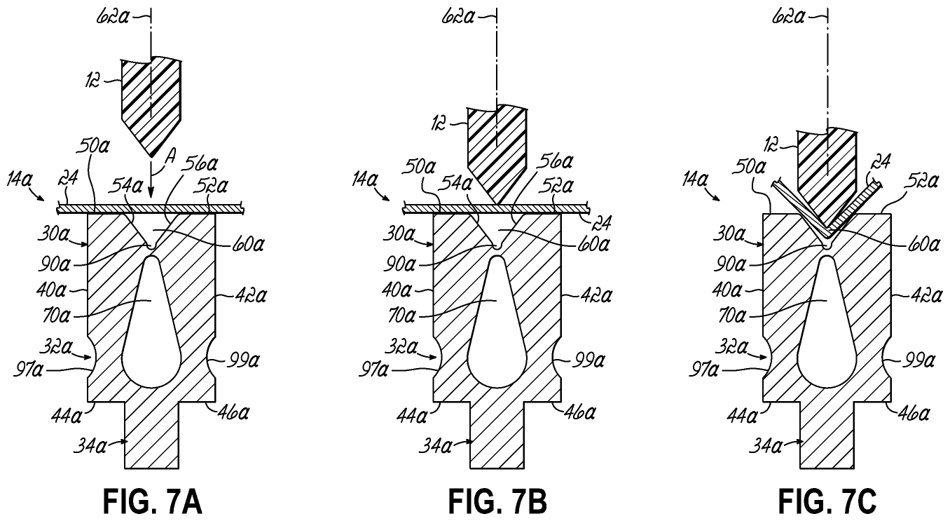

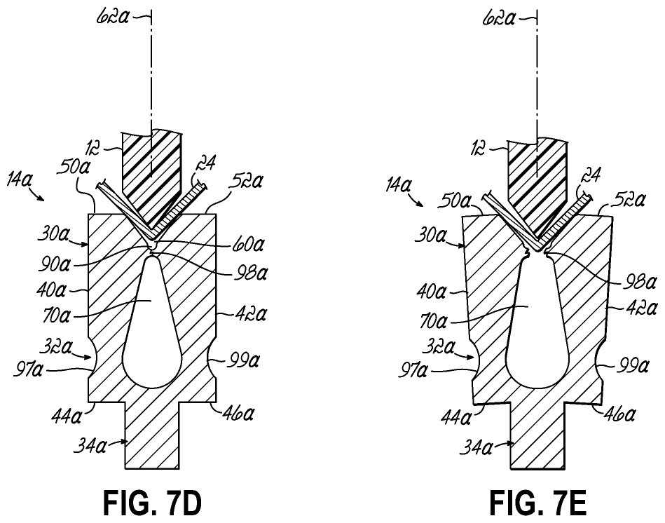

Referring now to FIGS. 7A-7E, a guided failure of the die 14a when overloaded by the punch 12 is illustrated. Initially, the flat workpiece 24 is positioned between the punch 12 and the loading surfaces 50a, 52a, 54a, 56a of the die 14a, such as the upper loading surfaces 50a, 52a. The punch 12 is advanced toward the workpiece 24, and thus the die 14a, along the loading axis 62a as indicated by the arrow A (FIG. 7A). When the punch 12 begins to engage the workpiece 24, the load on the die 14a may be substantially vertical (e.g., parallel to the loading axis 62a) as the force is applied to the upper loading surfaces 50a, 52a of the die 14 via the workpiece 24 (FIG. 7B). The load on the die 14a rotates away from vertical as the workpiece 24 is bent deeper into the V-notch 60a, and the final load on the die 14a may be angled relative to vertical (e.g., relative to the loading axis 62a) as the force is applied to the angled loading surfaces 54a, 56a via the bent workpiece 24 (FIG. 7C). The weakened portion may fail in tension when the die 14a is overloaded by the force applied by the punch 12 to the angled loading surfaces 54a, 56a, resulting in a fracture or crack 98a along the loading axis 62a between the V-notch 60a (and/or depression 90a) and the upper end 72a of the slot 70a (FIG. 7D) before any explosive or catastrophic breakage can occur and thus prevent the portions of the tool body 30a on either side of the crack 98a, slot 70a, and/or axis 62a from being propelled. After the weakened portion fails in this manner, thereby causing a significant reduction in the load applied to the die 14a, the portions of the tool body 30a on either side of the crack 98a, slot 70a, and/or axis 62a can flex away from each other without explosive or catastrophic breakage (FIG. 7E).

Thus, the intended strategic weakness is capable of controlling the force profile applied to the die 14a by the punch 12 so as to control the failure of the die 14a along an intended and predetermined fault line that allows the die 14a to split substantially down the middle of the die 14a. In one embodiment, the force resistance or stiffness of the die 14a at or near the angled loading surfaces 54a, 56a may be significantly reduced when the splitting failure (e.g., propagation of the crack 98a) occurs. This may effectively reduce the spring constant of the portions of the tool body 30a on either side of the crack 98a, slot 70a, and/or axis 62a, thereby allowing them to readily flex away from each other rather than catastrophically explode. In one embodiment, the printing direction used during manufacture of the die 14a may contribute to the flexibility of the die 14a in accomplishing this action. In addition or alternatively, the load applied to the die 14a may reduce immediately to a small percentage of the original load once the splitting failure occurs. For example, the load applied to the die 14a immediately after the splitting failure may reduce to less than 10% of the original load applied to the die 14a by the punch 12. Thus, the stresses in the die 14a may nearly dissipate immediately.

In this manner, the die 14a may be constructed of a relatively weak, printed material that may be susceptible to failure when overloaded. However, such failure is guided in a safe manner. In particular, the intended strategic weaknesses provided in the die 14a determine in advance the direction of the failure and reduce the total energy of the failure relative to that of higher strength and/or higher factor of safety designs. Thus, the 3D printed die 14a may be safe for normal operation of the press brake 10, even if rated at a relatively low factor of safety compared to tools manufactured via more traditional techniques.

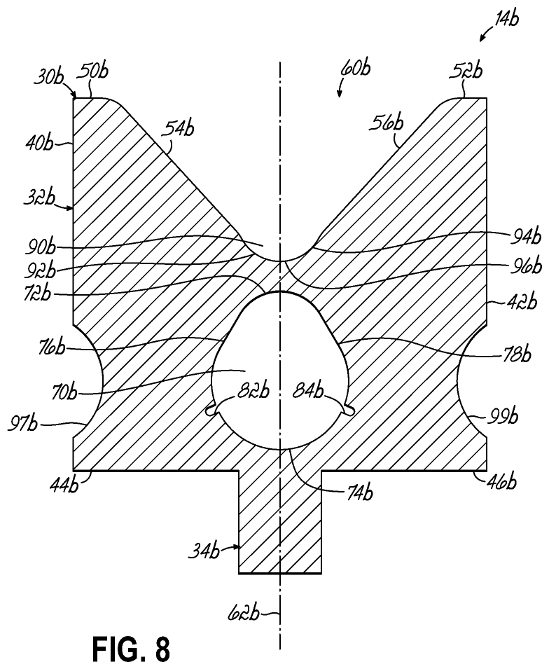

Referring now to FIG. 8, an alternative die 14b includes a tool body 30b having a main portion 32b and a stem portion 34b extending between first and second ends (not shown). The main portion 32b includes first and second sides 40b, 42b, first and second lower support surfaces 44b, 46b, and first and second upper loading surfaces 50b, 52b generally parallel to the first and second lower support surfaces 44b, 46b. The main portion 32b also includes first and second angled loading surfaces 54b, 56b configured to assist in shaping the workpiece 24 when the workpiece 24 is pressed between the punch 12 and the die 14b. In this regard, the angled loading surfaces 54b, 56b together define a V-shaped die opening or V-notch 60b and further define a loading axis 62b provided at or near an apex of the V-notch 60b. The illustrated loading axis 62b is generally centered between the first and second sides 40a, 42b. In one embodiment, the V-notch 60b may be defined by a die angle of about 85°, for example.

As shown, the stem portion 34b is positioned along the loading axis 62b and is configured to be received by a clamp, for example, in order to secure the die 14b to the bed 20 of the press brake 10. The first and second support surfaces 44b, 46b are positioned on the main portion 32b proximate the stem portion 34b and may be configured to rest upon or otherwise receive such a clamp, for example, in order to assist in stabilizing the die 14b on the bed 20 of the press brake 10.

The illustrated die 14b further includes a first intended structural weakness portion or structural fuse in the form of a slot 70b extending between the first and second ends of the tool body 30b and positioned along the axis 62b in the main portion 32b between the loading surfaces 50b, 52b, 54b, 56b and the support surfaces 44b, 46b. The slot 70b is a calibrated weak spot in the tool body 30b which provides for a predetermined, guided failure of the die 14b when overloaded. The slot 70b may be configured to direct and control an ultimate failure of the die 14b, to reduce applied forces after failure occurs, and/or to allow the die 14b to flex after failure rather than explode or shatter.

In this regard, the slot 70b extends along the loading axis 62a between an upper end 72b and a lower end 74b and is closed off from the loading surfaces 50b, 52b, 54b, 56b. In the embodiment shown, the slot 70b includes first and second slot surfaces 76b, 78b angled relative to each other, the upper end 72b is partially defined by a first radius, and the lower end 74b is partially defined by a second radius greater than the first radius such that the slot 70b is generally teardrop-shaped somewhat similar to the embodiment of FIG. 6. As a result, the portion of the body 30b extending between the upper end 72b of the slot 70b and the V-notch 60b has a reduced material thickness and is structurally weak relative to the remaining portions of the body 30b. Thus, the die 14b may be prone to fracture along the weakened portion of the body 30b when overloaded, in a manner similar to that described above with respect to the die 14.

The illustrated slot 70b includes first and second outwardly-extending notches 82b, 84b provided along the first and second slot surfaces 76b, 78b at or near the lower end 74b of the slot 70b. The first and second notches 82b, 84b may serve as an additional guide for controlling the split between portions of the die 14b on either side of the loading axis 62b when the die 14b is overloaded. The first and second notches 82b, 84b may be present in embodiments where the main portion 32b of the tool body 30b is relatively short and/or relatively wide. In other embodiments, the first and second notches 82b, 84b may be eliminated, such as in embodiments where the main portion 32b of the tool body 30b is relatively tall and/or relatively narrow. In such cases, the split between portions of the die 14b on either side of the loading axis 62b may occur on its own without additional guidance.

In the embodiment shown, the die 14b includes a second intended structural weakness portion in the form of a depression 90b extending between the first and second ends of the tool body 30b and positioned along the axis 62b and opening to the first and second angled loading surfaces 54b, 56b. In this regard, the depression 90b is provided at or near the apex of the V-notch 60b. In the embodiment shown, the depression 90b includes first and second depression surfaces 92b, 94b angled relative to each other and an end 96b partially defined by a radius such that the depression 90b may be generally U-shaped. The depression 90b may further weaken the weakened portion of the body 30b extending between the upper end 72b of the slot 70b and the V-notch 60b by further reducing the material thickness of the weakened portion. Thus, the depression 90b may contribute to the tendency of the die 14b to fracture along the weakened portion of the body 30b when overloaded.

The illustrated die 14b also includes a third intended structural weakness portion in the form of first and second grooves 97b, 99b extending along the first and second sides 40b, 42b of the main portion 32b of the tool body 30b. The grooves 97b, 99b may provide an increased load carrying capacity of the die 14b during the bending process while adding flexibility to improve energy dissipation after the weakened portion of the body 30b has fractured. The first and second grooves 97b, 99b may be included in embodiments where the die 14a is constructed of relatively brittle materials, for example.

In one embodiment, the length of each of the first and second notches 82b, 84b may be approximately 0.047 in and the width of each of the first and second notches 82b, 84b may be approximately 0.052 in. The illustrative dimensions provided herein are exemplary and are not intended to be limiting.

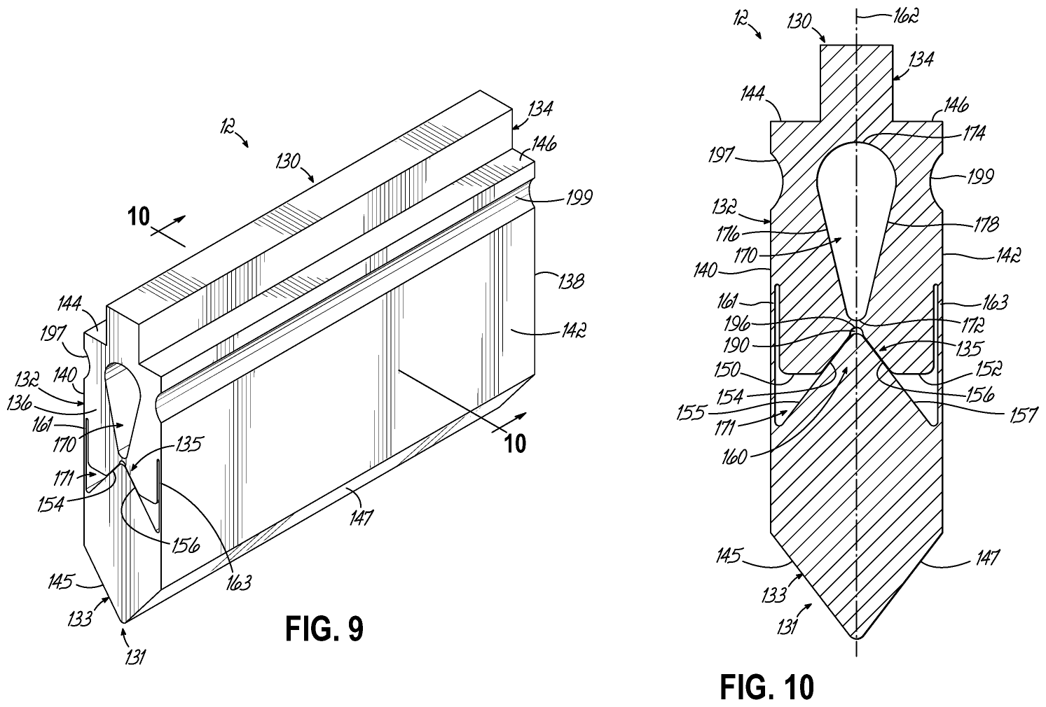

Referring now to FIGS. 9 and 10, the printed tool of the invention is in the form of a punch 12. The illustrated punch 12 includes a first or upper tool body portion or “base” 130 and a second or lower tool body portion or “nose” 131. The portions 130, 131 are configured to operate together. In the illustrated embodiment, the portions are integrally formed together as a unitary piece. As shown, the upper tool body portion 130 may have a configuration generally similar to that of the die 14a described above with respect to FIG. 6. In this regard, the upper tool body portion 130 has a main portion 132 and a stem portion 134, and both the upper and lower tool body portions 130, 131 extend between first and second ends 136, 138. The main portion 132 at least partially defines first and second sides 140, 142 of the punch 12, and includes first and second upper support surfaces 144, 146, and first and second lower loading surfaces 150, 152 generally parallel to the first and second upper support surfaces 144, 146. The main portion 132 also includes first and second angled loading surfaces 154, 156, which together define a V-notch 160 having an apex at or near a loading axis 162 of the punch 12. The illustrated loading axis 162 is generally centered between the first and second sides 140, 142. In one embodiment, the V-notch 160 may be defined by an angle of about 75°, for example.

As shown, the stem portion 134 is positioned along the loading axis 162 and is configured to be received by a clamp, for example, in order to secure the punch 12 to the ram 22 of the press brake 10. The first and second support surfaces 144, 146 are positioned on the main portion 132 proximate the stem portion 134 and may be configured to abut or otherwise receive such a clamp, for example, in order to assist in stabilizing the punch 12 on the ram 22 of the press brake 10.

The illustrated punch 12 further includes a first intended structural weakness or structural fuse in the form of a slot 170 extending between the first and second ends 136, 138 of the upper tool body 130 and positioned along the axis 162 in the main portion 132 between the loading surfaces 150, 152, 154, 156 and the support surfaces 144, 146. The slot 170 is a calibrated weak spot in the upper tool body 130 which provides for a predetermined, guided failure of the punch 12 when overloaded. The slot 170 may be configured to direct and control an ultimate failure of the punch 12, to reduce applied forces after failure occurs, and/or to allow the punch 12 to flex after failure rather than explode or shatter. The slot 170 can take the form of the various slots as shown in the embodiments of FIGS. 3, 6, and 8.

In this regard, the slot 170 extends along the loading axis 162 between a lower end 172 and an upper end 174 and is closed off from the loading surfaces 150, 152, 154, 156. In the embodiment shown in FIG. 10, the slot 170 includes first and second slot surfaces 176, 178 angled relative to each other, the upper end 174 is partially defined by a first radius, and the lower end 172 is partially defined by a second radius less than the first radius such that the slot 170 is generally teardrop-shaped similar to the slot in FIG. 6. As a result, the portion of the upper tool body 130 extending between the lower end 172 of the slot 170 and the V-notch 160 has a reduced material thickness and is intentionally structurally weak relative to the remaining portions of the body 130. Thus, the punch 12 may be prone to fracture along the intentionally weakened portion of the upper tool body 130 when overloaded, as described below.

In the embodiment shown, the punch 12 includes a depression 190 extending between the first and second ends 136, 138 of the tool body 130 and positioned along the axis 162 and opening to the first and second angled loading surfaces 154, 156. In this regard, the depression 190 is provided at or near the apex of the V-notch 160. In the embodiment shown, the depression 190 includes an end 196 partially defined by a radius such that the depression 190 may be generally U-shaped. The depression 190 may further weaken the weakened portion of the body 130 extending between the lower end 172 of the slot 170 and the V-notch 160 by further reducing the material thickness of the weakened portion. Thus, the depression 190 may contribute to the tendency of the punch 12 to fracture along the weakened portion of the body 130 when overloaded.

The illustrated punch 12 also includes first and second grooves 197, 199 extending along the first and second sides 140, 142 of the main portion 132 of the upper tool body 130. The grooves 197, 199 may provide an increased load carrying capacity of the punch 12 during the bending process while adding flexibility to improve energy dissipation after the weakened portion of the upper tool body 130 has fractured. The first and second grooves 197, 199 may be included in embodiments where the punch 12 is constructed of relatively brittle materials, for example. In that regard, the upper tool body portion resembles the embodiment of FIG. 6 in many ways.

As shown, the lower tool body portion 131 may have a configuration generally complementary to both that of the die 14 described above and that of the upper tool body portion 130. In this regard, the lower tool body 131 has a lower V-shaped tip portion 133 and an upper V-shaped wedge portion 135. The lower V-shaped tip portion 133 includes first and second lower angled loading surfaces 145, 147 configured to cooperate with the V-notch 60 of the die 14 to shape the workpiece 24 when the workpiece 24 is pressed between the punch 12 and the die 14, and the upper V-shaped wedge portion 135 includes first and second upper angled loading surfaces 155, 157 configured to be received by the V-notch 160 of the upper tool body 130 such that the first and second upper angled loading surfaces 155, 157 may confront the first and second angled loading surfaces 154, 156 and may be in contact or near-contact therewith. The lower V-shaped tip portion 133 and the upper V-shaped wedge portion 135 each have an apex at or near the loading axis 162 of the punch 12. In one embodiment, the lower V-shaped tip portion 133 and the upper V-shaped wedge portion 135 may each be defined by an angle of about 75°, for example.

In the embodiment shown, first and second relatively thin and/or flexible tabs 161, 163 extend proximate to or along the first and second opposing sides 140, 142 of the punch 12 between the upper and lower tool body portions 130, 131 to couple the upper and lower tool body portions 130, 131 together. The illustrated first and second thin tabs 161, 163 are integrally formed together with the upper and lower tool body portions 130, 131 such that the body portions form a unitary piece or body.

As shown, the punch 12 includes a second intended structural weakness portion in the form of a generally W-shaped slot 171 defined between the upper and lower tool bodies 130, 131 and the first and second thin tabs 161, 163. In the embodiment shown, the W-shaped slot 171 includes the depression 190, as well as the spaces or interfaces between the first and second upper angled loading surfaces 155, 157 and the first and second angled loading surfaces 154, 156 and the spaces between the tabs 161, 163 and the upper tool body portions. In any event, the first and second thin tabs 161, 163 are configured to flex and/or fracture when the punch 12 is overloaded to allow the upper V-shaped wedge portion 135 to plunge deeper into the V-notch 160 so that at least some or all of the forces exerted upon the lower V-shaped tip portion 133 may be transferred to the first and second angled loading surfaces 154, 156 to ultimately trigger a guided fracture of the punch 12 along the structural weakness portion of the upper tool body 130 into the slot 170, in a manner similar to that described above with respect to the overloading of the die 14, as described below.

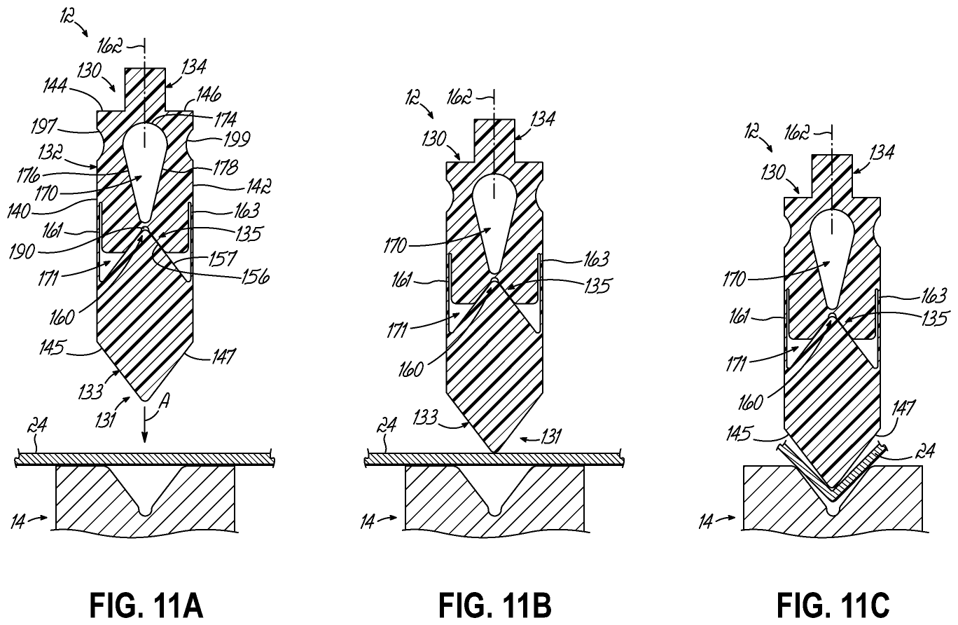

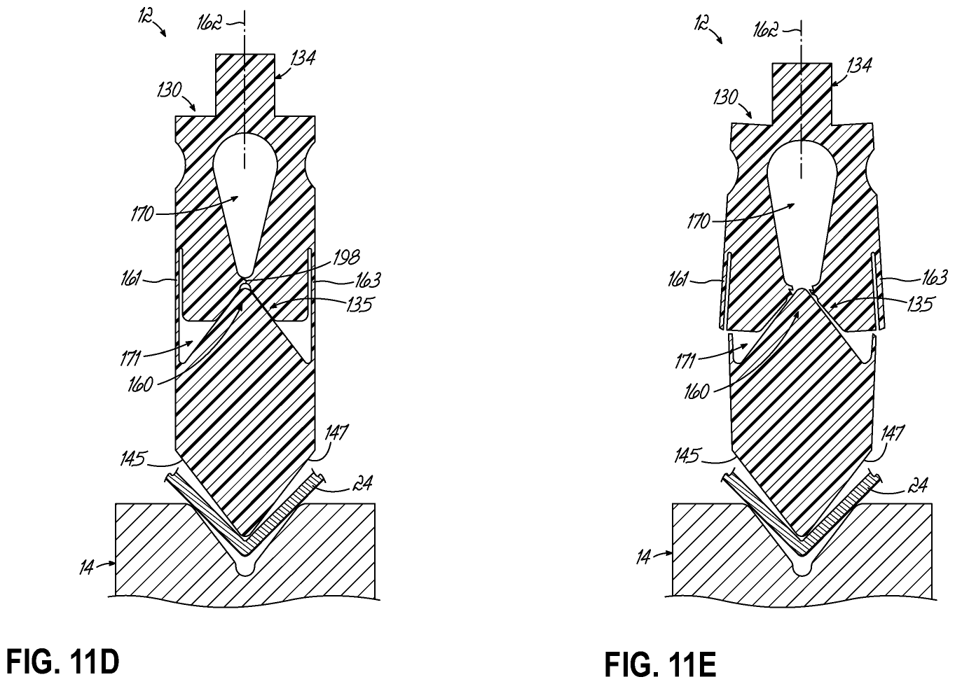

Referring now to FIGS. 11A-11E, a guided failure of the punch 12 when overloaded by the die 14 is illustrated. Initially, the flat workpiece 24 is positioned between the die 14 and the angled loading surfaces 145, 147 of the punch 12. The punch 12 is advanced toward the workpiece 24, and thus the die 14, along the loading axis 162 as indicated by the arrow A (FIG. 11A). When the punch 12 begins to engage the workpiece 24, the load on the punch 12 may be substantially vertical (e.g., parallel to the loading axis 162) as the counterforce is applied by the die 14 to the apex of the lower tip portion 133 of the punch 12 via the workpiece 24 (FIG. 11B). The load on the punch 12 rotates away from vertical as the workpiece 24 is bent about the lower tip portion 133, and the final load on the punch 12 may be angled relative to vertical (e.g., relative to the loading axis 162) as the force is applied to the angled loading surfaces 145, 147 via the bent workpiece 24 (FIG. 11C). The thin tabs 161, 163 may flex and/or fracture, allowing the upper V-shaped wedge portion 135 to plunge deeper into the V-notch 160 so that the forces exerted upon the lower V-shaped tip portion 133 may be transferred to the first and second angled loading surfaces 154, 156 of the upper tool body 130 via the upper V-shaped wedge portion 135. The weakened portion between the slot 170 and the V-notch 160 (and/or depression 190) may fail in tension when the upper tool body 130 is overloaded by the force applied by the V-shaped wedge portion to the angled loading surfaces 154, 156, resulting in a fracture or crack 198 along the loading axis 162 between the V-notch 160 (and/or depression 190) and the lower end 172 of the slot 170 (FIG. 11D) before any explosive or catastrophic breakage can occur and thus prevent the portions of the upper tool body 130 on either side of the crack 198, slot 170, and/or axis 162 from being propelled. After the weakened portion fails in this manner, thereby causing a significant reduction in the load applied to the punch 12, the portions of the upper tool body 130 on either side of the crack 198, slot 170, and/or axis 162 can flex away from each other without explosive or catastrophic breakage, while the lower tool body 131 may remain relatively intact with the possible exception of fractured thin tabs 161, 163 (FIG. 11E).

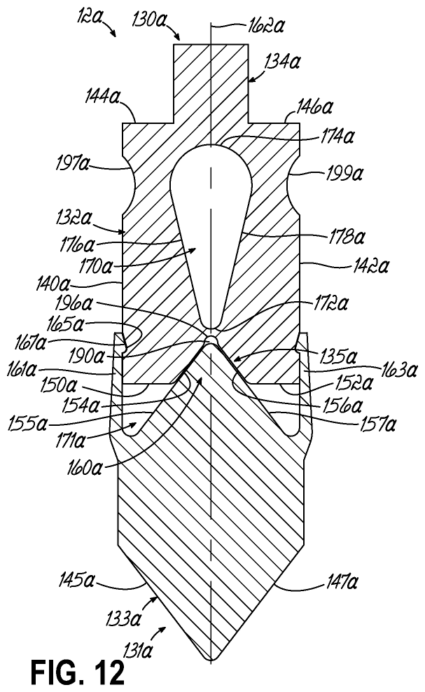

Referring now to FIG. 12, an alternative punch 12a includes a first or upper tool body portion or “base” 130a and a second lower tool body portion or “nose” 131a separately formed as distinct pieces and removably coupled to each other. As shown, the upper tool body portion 130a may have a configuration generally similar to that of the die 14a described above with respect to FIG. 6. In one embodiment, the upper tool body portion 130a may be configured to provide a function similar to that of the die 14a when the upper tool body 130a is detached from the lower tool body 131a, and may thus be referred to as a “die.” In this regard, the upper tool body portion 130a has a main portion 132a and a stem portion 134a, and both the upper and lower tool bodies 130a, 131a extend between first and second ends (not shown). The main portion 132a at least partially defines first and second sides 140a, 142a of the punch 12a, and includes first and second upper support surfaces 144a, 146a, and first and second lower loading surfaces 150a, 152a generally parallel to the first and second upper support surfaces 144a, 146a. The main portion 132a also includes first and second angled loading surfaces 154a, 156a, which together define a V-notch 160a having an apex at or near a loading axis 162a of the punch 12a. The illustrated loading axis 162a is generally centered between the first and second sides 140a, 142a. In one embodiment, the V-notch 160a may be defined by an angle of about 75°, for example.

As shown, the stem portion 134a is positioned along the loading axis 162a and is configured to be received by a clamp, for example, in order to secure the punch 12a to the ram 22 of the press brake 10. The first and second support surfaces 144a, 146a are positioned on the main portion 132a proximate the stem portion 134a and may be configured to abut or otherwise receive such a clamp, for example, in order to assist in stabilizing the punch 12a on the ram 22 of the press brake 10.

The illustrated punch 12a further includes a first intended structural weakness portion or structural fuse in the form of a slot 170a extending between the first and second ends (not shown) of the upper tool body portion 130a and positioned along the axis 162a in the main portion 132a between the loading surfaces 150a, 152a, 154a, 156a and the support surfaces 144a, 146a. The slot 170a is a calibrated weak spot in the upper tool body portion 130a which provides for a predetermined, guided failure of the punch 12a when overloaded. The slot 170a may be configured to direct and control an ultimate failure of the punch 12a, to reduce applied forces after failure occurs, and/or to allow the punch 12a to flex after failure rather than explode or shatter.

In this regard, the slot 170a extends along the loading axis 162a between a lower end 172a and an upper end 174a and is closed off from the loading surfaces 150a, 152a, 154a, 156a. In the embodiment shown, the slot 170a includes first and second slot surfaces 176a, 178a angled relative to each other, the upper end 174a is partially defined by a first radius, and the lower end 172a is partially defined by a second radius less than the first radius such that the slot 170a is generally teardrop-shaped. As a result, the portion of the upper tool body portion 130a extending between the lower end 172a of the slot 170a and the V-notch 160a has a reduced material thickness and is intentionally structurally weak relative to the remaining portions of the body portion 130a. Thus, the punch 12a may be prone to fracture along the intentionally weakened portion of the upper tool body portion 130a when overloaded, as described below.

In the embodiment shown, the punch 12a includes a depression 190a extending between the first and second ends (not shown) of the tool body portion 130a and positioned along the axis 162a and opening to the first and second angled loading surfaces 154a, 156a. In this regard, the depression 190a is provided at or near the apex of the V-notch 160a. In the embodiment shown, the depression 190a includes an end 196a partially defined by a radius such that the depression 190a may be generally U-shaped. The depression 190a may further weaken the weakened portion of the body 130a extending between the lower end 172a of the slot 170a and the V-notch 160a by further reducing the material thickness of the weakened portion. Thus, the depression 190a may contribute to the tendency of the punch 12a to fracture along the weakened portion of the body 130a when overloaded.

The illustrated punch 12a also includes first and second grooves 197a, 199a extending along the first and second sides 140a, 142a of the main portion 132a of the upper tool body portion 130a. The grooves 197a, 199a may provide an increased load carrying capacity of the punch 12a during the bending process while adding flexibility to improve energy dissipation after the weakened portion of the body portion 130a has fractured. The first and second grooves 197a, 199a may be included in embodiments where the punch 12a is constructed of relatively brittle materials, for example.

As shown, the lower tool body portion 131a may have a configuration generally complementary to both that of the die 14 described above and that of the upper tool body portion 130a. In this regard, the lower tool body 131a has a lower V-shaped tip portion 133a and an upper V-shaped wedge portion 135a. The lower V-shaped tip portion 133a includes first and second lower angled loading surfaces 145a, 147a configured to cooperate with the V-notch 60 of the die 14 to shape the workpiece 24 when the workpiece 24 is pressed between the punch 12a and the die 14, and the upper V-shaped wedge portion 135a includes first and second upper angled loading surfaces 155a, 157a configured to be received by the V-notch 160a of the upper tool body 130a such that the first and second upper angled loading surfaces 155a, 157a may confront the first and second angled loading surfaces 154a, 156a and may be in contact or near-contact therewith. The lower V-shaped tip portion 133a and the upper V-shaped wedge portion 135a each have an apex at or near the loading axis 162a of the punch 12a. In one embodiment, the lower V-shaped tip portion 133a and the upper V-shaped wedge portion 135a may each be defined by an angle of about 75°, for example.

In the embodiment shown, first and second relatively thin and/or flexible tabs 161a, 163a extend along the first and second sides 140a, 142a of the punch 12a between the upper and lower tool body portions 130a, 131a to couple the upper and lower tool body portions 130a, 131a together. The illustrated first and second thin tabs 161a, 163a are integrally form ed together with the lower tool body portion 131a as a unitary piece, and include respective detents 165a configured to be received by corresponding indents 167a provided on the upper tool body portion 130a to provide a secure snap-fit therebetween. In this manner, the lower tool body 131a may be selectively attached to the upper tool body (or “die”) 130a to form the punch 12a. While the illustrated punch 12a includes the detents 165a and indents 167a, the lower tool body 131a may be selectively attached to the upper tool body 130a in any other suitable manner. For example, the tabs 161a, 163a may be on upper body portion 130a, while the indents may be in the lower tool body portion 131a.

As shown, the punch 12a includes a second intended structural weakness in the form of a generally W-shaped slot 171a defined between the upper and lower tool bodies 130a, 131a and the first and second thin tabs 161a, 163a. In the embodiment shown, the W-shaped slot 171a includes the depression 190a, as well as the spaces or interfaces between the first and second upper angled loading surfaces 155a, 157a and the first and second angled loading surfaces 154a, 156a. In any event, the first and second thin tabs 161a, 163a are configured to flex and/or fracture when the punch 12a is overloaded to allow the upper V-shaped wedge portion 135a to plunge deeper into the V-notch 160a so that at least some or all of the forces exerted upon the lower V-shaped tip portion 133a may be transferred to the first and second angled loading surfaces 154a, 156a to ultimately trigger a guided fracture of the punch 12a along the intentionally weakened portion of the upper tool body portion 130a into the slot 170a, in a manner similar to that described above with respect to the punch 12.

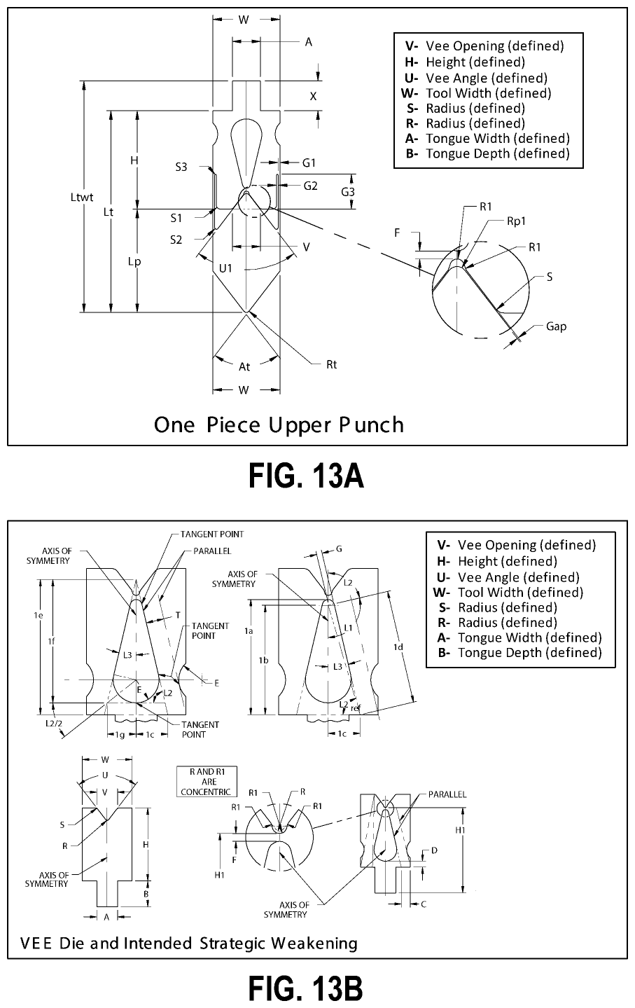

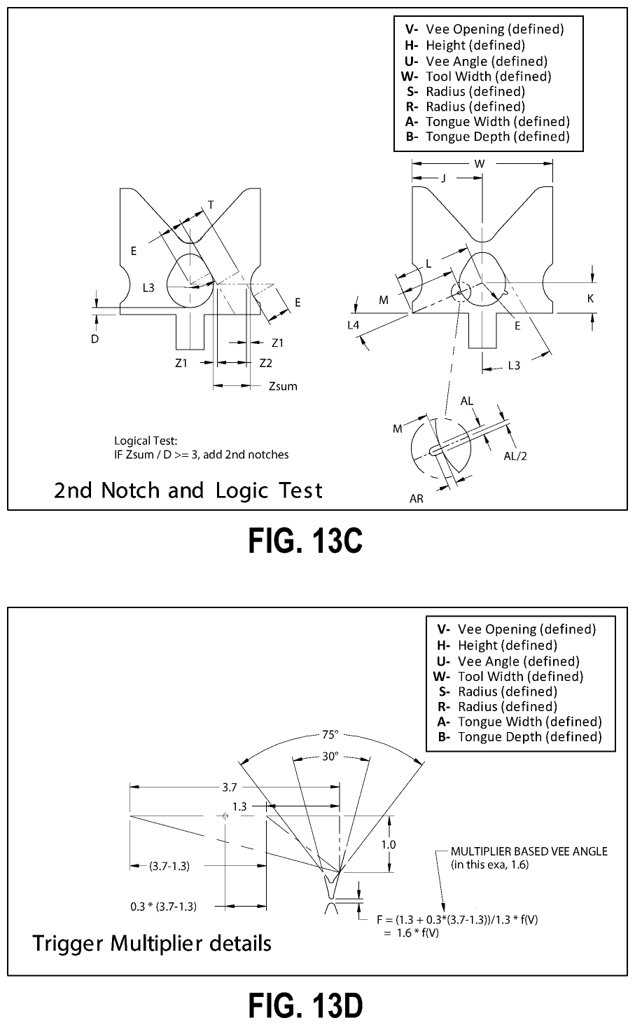

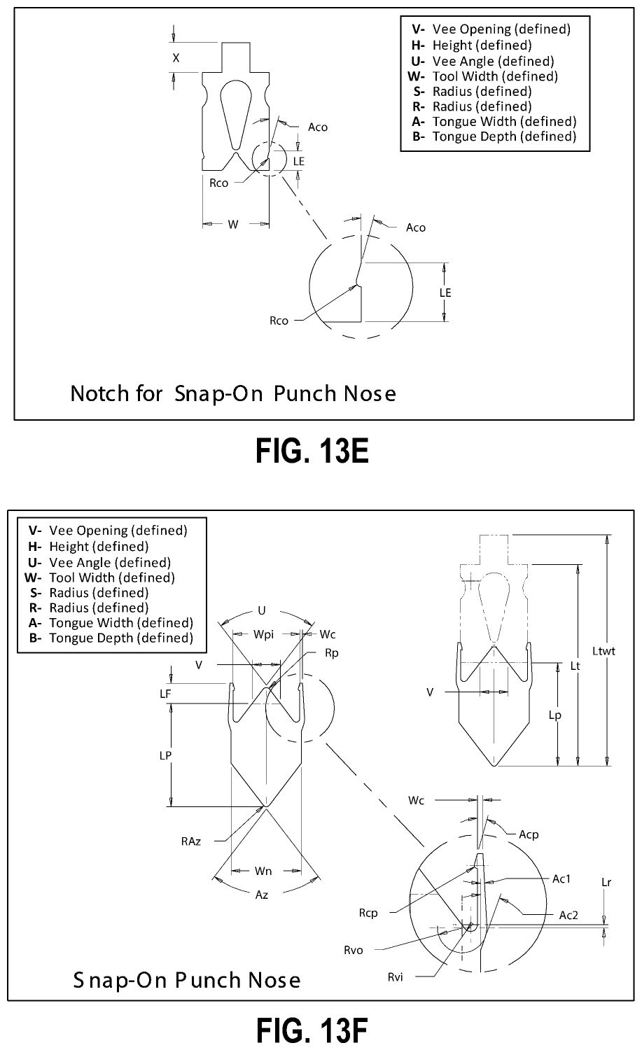

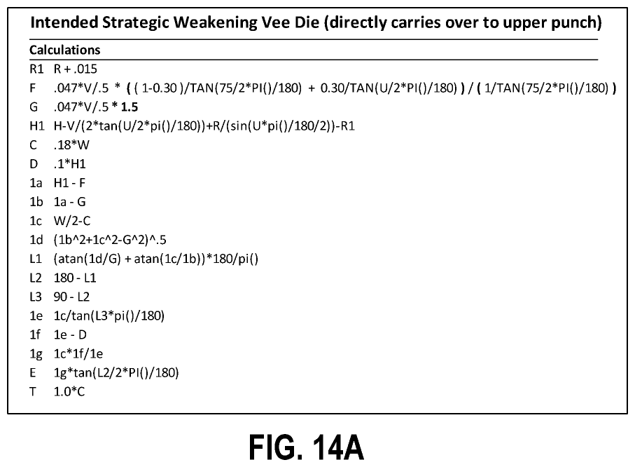

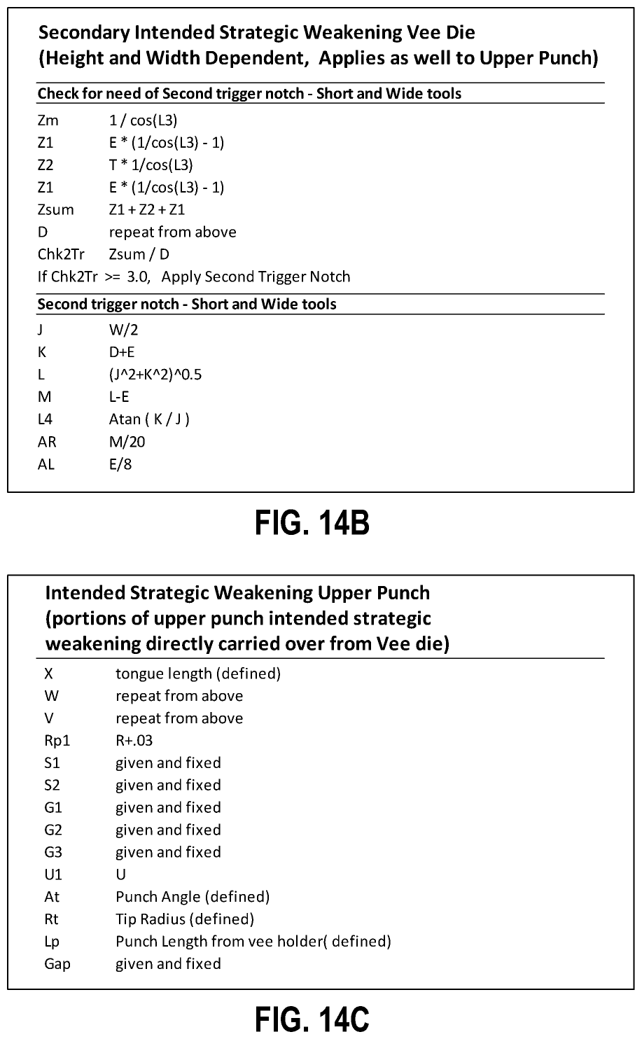

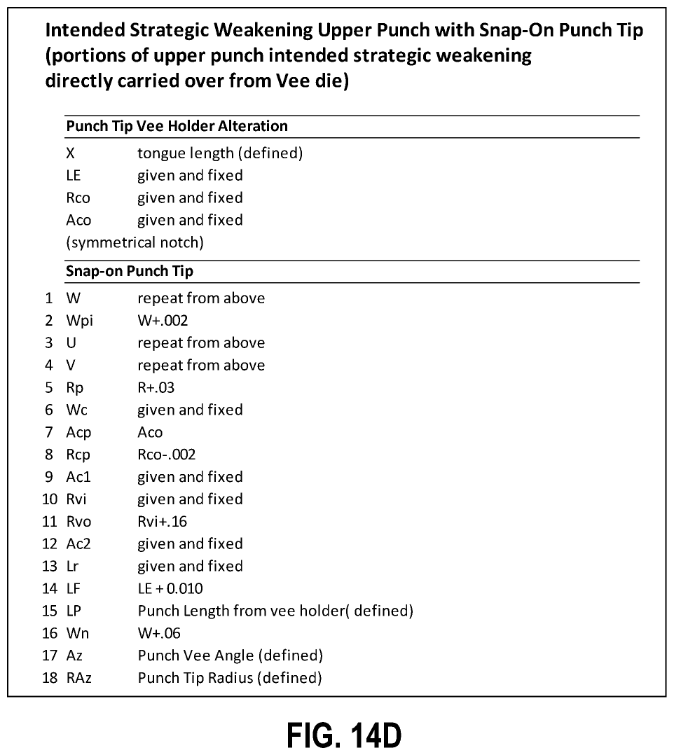

In one embodiment, certain dimensional aspects of the punch 12, 12a and/or die 14, 14a, 14b may be determined based on the desired application including, for example, the desired shaping of the workpiece 24 during operation of the press brake 10 and the configuration of the clamping device of the press brake 10, while other dimensional aspects of the punch 12, 12a, and/or die 14, 14a, 14b may be selected based on the exemplary parameters defined in FIGS. 13A-13F and/or FIGS. 14A-14D. For example, some or all of the outer dimensional aspects of the punch 12, 12a and/or die 14, 14a, 14b may be determined based on the desired application and may therefore be considered independent variables or “givens,” while some or all of the internal dimensional aspects (e.g., relating to the intended strategic weaknesses) may be selected based on a desired relationship of such dimensional aspects to the independent variables and may therefore be considered dependent variables or “calculations.”

In one embodiment, inclusion of the first and second notches 82b, 84b shown in FIG. 8 may also be determined based on at least some of the exemplary parameters defined in FIGS. 13A-13F and/or 14A-14D. For example, the first and second notches 82b, 84b may be included if the dimensional relationship provided therein is satisfied, and may be excluded if the such dimensional relationship is not satisfied.

Although the exemplary punches 12, 12a are shown mounted to the ram 22 and the exemplary dies 14, 14a, 14b are shown mounted to the bed 20 to provide upward bending, it will be appreciated that inverted arrangements are possible, such as wherein the punches 12, 12a are mounted to the bed 20 and the dies 14, 14a, 14b are mounted to the ram 22 to provide downward bending, for example.

While the 3D printed tool has been described herein in the form of a punch 12, 12a or a die 14, 14a, 14b it will be appreciated that any other 3D printed tool may be configured with one or more suitable intended structural weakness portions. In this regard, while the intended structural weakness portions have been primarily described as being provided by voids such as slots 70, 70a, 70b, 170, 170a and depressions 90, 90a, 90b, 190a, 190b, it will be appreciated that any other suitable intended structural weakness portions or elements may be used. For example, an intended structural weakness portion may be provided by a region of the tool body 30, 30a (e.g., corresponding to the illustrated slots 70, 70a and/or weakened portion 80) being constructed of a relatively weaker material than the remaining portions of the tool body 30, 30a. In addition or alternatively, an intended structural weakness may be provided by a porous region of the tool body 30, 30a (e.g., corresponding to the illustrated slots 70, 70a and/or weakened portion 80).

While the present invention has been illustrated by the description of various embodiments thereof, and while the embodiments have been described in considerable detail, it is not intended to restrict or in any way limit the scope of the appended claims to such detail. Thus, the various features discussed herein may be used alone or in any combination. Additional advantages and modifications will readily appear to those skilled in the art. The present invention in its broader aspects is therefore not limited to the specific details and illustrative examples shown and described. Accordingly, departures may be made from such details without departing from the scope of the general inventive concept.

What is claimed is:

1. A 3D printed tool comprising:
a tool body extending between first and second ends;
at least one loading surface on the body;
at least one support surface on the body configured to receive a clamp;
an axis defined in the body extending between the at least one loading surface and at least one support surface;
a structural weakness portion positioned in the body and positioned generally along the axis between the at least one loading surface and the at least one support surface;
the structural weakness portion configured to cause the body to fail along a predetermined fault line when the tool body is overloaded at the at least one loading surface.

2. The 3D printed tool of claim 1, wherein the at least one loading surface includes first and second angled loading surfaces defining a V-notch.

3. The 3D printed tool of claim 1, wherein the at least one structural weakness portion includes at least one depression positioned along the axis and opening to the at least one loading surface.

4. The 3D printed tool of claim 1, wherein the at least one structural weakness portion includes at least one slot.

5. The 3D printed tool of claim 4, wherein the at least one slot is positioned along the axis and closed off from the at least one loading surface.

6. The 3D printed tool of claim 4, wherein the at least one slot is generally teardrop-shaped.

7. The 3D printed tool of claim 4, wherein the at least one slot is generally W-shaped.

8. The 3D printed tool of claim 4, wherein the at least one slot extends between the first and second ends of the at least one tool body.

9. The 3D printed tool of claim 4, wherein the at least one slot includes first and second notches provided along first and second surfaces of the slot, respectively.

10. The 3D printed tool of claim 4, wherein the at least one tool body includes first and second tool body portions configured to operate together, the at least one slot is at least partially defined between the first and second tool body portions.

11. The 3D printed tool of claim 1 wherein the tool body is in the form of at least one of a die or a punch.

12. The 3D printed tool of claim 1, wherein the tool body includes first and second tool body portions configured to operate together, the structural weakness portion including at least one slot formed in a first tool body portion and at least one slot partially defined between the first and second tool body portions.

13. The 3D printed tool of claim 10, wherein at least one tool body portion includes angled loading surfaces defining a V-notch and another of the tool body portions includes angled loading surfaces configured for engaging the V-notch.

14. The 3D printed tool of claim 1, wherein tool body includes first and second tool body portions configured to operate together, the first and second tool body portions coupled together with thin tabs proximate opposing sides of the tool body portions.

15. The 3D printed tool of claim 1, wherein the tool body includes a plurality of structural weakness portions positioned in the body and positioned generally along the axis between the at least one loading surface and the at least one support surface, the plurality of structural weakness portions cooperating to cause the tool body to fail along a predetermined fault line when the tool body is overloaded at the at least one loading surface.

16. A 3D printed tool comprising:
a tool body extending between first and second ends, the tool body including a plurality of tool body portions configured to operate together;
at least one loading surface on a body portion of the tool body;
at least one support surface on another body portion of the tool body configured to receive a clamp;
an axis defined in the body extending between the tool body portions and the at least one loading surface and at least one support surface;
a structural weakness portion positioned in at least one of the body portions of the tool body and positioned generally along the axis between the at least one loading surface and the at least one support surface;
the structural weakness portion configured to cause the body to fail along a predetermined fault line when the tool body is overloaded at the at least one loading surface.

17. The 3D printed tool of claim 16 further comprising a structural weakness portion positioned in a plurality of body portions of the tool body, each structural weakness portion positioned generally along the axis between the at least one loading surface and the at least one support surface.

18. The 3D printed tool of claim 17 wherein the first and second tool body portions are coupled together with thin tabs proximate opposing sides of the tool body portions.

19. The 3D printed tool of claim 16, wherein the structural weakness portion includes at least one slot formed in a tool body portion.

20. The 3D printed tool of claim 19, wherein the at least one slot is one of generally teardrop-shaped or generally W-shaped.
